(19) United States
(12) Patent Application Publication
(10) Pub. No.: US 2026/0058695 A1
(43) Pub. Date: Feb. 26, 2026

(54) STRATYGE OPTIMIZATION ALGORITHMS FOR CELL-FREE MASSIVE MIMO SYSTEMS

(71) Applicant: CHONGQING UNIVERSITY OF POSTS AND TELECOMMUNICATIONS, Chongqing (CN)

(72) Inventors: Shichao XIA, Chongqing (CN); Zhixiu YAO, Chongqing (CN); Yun LI, Chongqing (CN); Guangfu WU, Chongqing (CN); Zhitong XING, Chongqing (CN)

(73) Assignee: CHONGQING UNIVERSITY OF POSTS AND TELECOMMUNICATIONS, Chongqing (CN)

(21) Appl. No.: 19/313,815

(22) Filed: Aug. 28, 2025

Related U.S. Application Data
(63) Continuation of application No. PCT/CN2025/070397, filed on Jan. 3, 2025.

(30) Foreign Application Priority Data
Aug. 21, 2024 (CN) 202411149227.2

(51) Int. Cl. H04B 7/0413; H04W 24/02

(52) U.S. Cl. CPC H04B 7/0413; H04W 24/02

(57) ABSTRACT

The present disclosure relates to a strategy optimization algorithm for a cell-free massive MIMO system, including: constructing a user association model, the user association model is configured to model an association relationship between the M mobile devices (MDs) and the N access points (APs) in each time slot; constructing a downlink signal model, the downlink signal model is configured to model a network achievable rate of the cell-free massive MIMO system in the each time slot; constructing a system energy consumption model, the system energy consumption model is configured to model a total energy consumption of all the N access points providing a content service in the each time slot; constructing a target optimization problem model based on the user association model, the downlink signal model, and the system energy consumption model, and using solving using a graph attention-based multi-agent reinforcement learning algorithm to obtain an optimal strategy.

### CROSS-REFERENCE TO RELATED APPLICATIONS

This application is a Continuation of International Application No. PCT/CN2025/070397, filed on Jan. 3, 2025, which claims priority to Chinese Patent Application No. 202411149227.2, filed on Aug. 21, 2024, the entire contents of each of which are hereby incorporated by reference.

### TECHNICAL FIELD

The present disclosure relates to the technical field of mobile communication technology, and in particular to a strategy optimization algorithm for a cell-free massive MIMO system.

### BACKGROUND

With the booming development of the Internet of Things (IoT) and edge computing technology, global communication traffic has exploded, posing a new technical challenge to a wireless network architecture. Due to inherent structured boundaries and centralized management mechanisms of traditional cellular networks, they have become difficult to efficiently meet demands of current complex and high-density communication services. To this end, the wireless communications field has begun to turn to research and exploration of new network architectures, in which cell-free massive MIMO (CF-mMIMO) is regarded as a promising solution. Unlike fixed boundaries of traditional cellular MIMO systems, CF-mMIMO provides services to users through a deployment of a large number of distributed nodes to achieve more uniform network coverage, and with its distributed network characteristics, it brings significant enhancements to flexibility and adaptability of communication networks.

Most prior art focuses on traditional CF-mMIMO network scenarios and homogeneous user service demands, and does not adequately consider the coupling among content caching deployment, user association, and resource allocation in a network environment of multi-user CF-mMIMO. In actual network scenarios, diverse user service demands, decentralized resource deployment, and dynamic network environments make resource management problems in CF-mMIMO networks highly complex. First of all, the diverse user service demands cause different APs to exhibit significant spatial variabilities in content caching, resource allocation, or the like, which poses a challenge to efficient collaboration among APs; second, the decentralized resource deployment of the CF-mMIMO network leads to an uneven resource distribution, which affects management performance and network resource usage efficiency among the APs; in addition, the dynamic nature of the network environment also causes profound uncertainty regarding network state and resource availability, making traditional user association and resource allocation strategies struggle to adapt to a highly dynamic and changing network environment.

In summary, the problem with prior art is that: dynamically changing demands of users in CF-mMIMO content caching networks affect AP caching deployment and AP resource allocation, and the limited caching capacity of wireless APs is insufficient to store all services that a user may request. Therefore, it is necessary to obtain a missing content from a forward link or a backhaul link, which will lead to increased delay in user content acquisition and poor quality of service.

Therefore, it is desirable to provide a strategy optimization algorithm for a cell-free massive MIMO system, to optimize caching and resource allocation strategies and to effectively improve the quality of service of the cell-free massive MIMO system.

### SUMMARY

In order to solve the problems in the background art, one or more embodiments of the present disclosure provide a strategy optimization algorithm for a cell-free massive MIMO system to learn optimal content caching, user association, and power allocation strategies, the cell-free massive MIMO system includes N access point (APs) with caching resources and M mobile device (MDs), the strategy optimization algorithm including:
S1: constructing a user association model, the user association model is configured to model an association relationship between the M mobile devices (MDs) and the N access points (APs) in each time slot.
S2: constructing a downlink signal model, the downlink signal model is configured to model a network achievable rate of the cell-free massive MIMO system in the each time slot;
S3: constructing a system energy consumption model, the system energy consumption model is configured to model a total energy consumption of all the N access points (APs) providing a content service in the each time slot.
S4: constructing a target optimization problem model based on the user association model, the downlink signal model, and the system energy consumption model.
S5: constructing the target optimization problem model as a partially observable Markov decision process (POMDP) model, and solving using a graph attention-based multi-agent reinforcement learning algorithm to obtain an association strategy between the N access points (APs) and the M mobile devices (MDs), a content caching strategy of the N access points (APs), and a power allocation strategy of the N access points (APs).

In some embodiments of the present disclosure, for a dynamic time-varying network environment and incomplete network state observation, the above joint optimization problem is abstracted into a decentralized partially observable Markov decision process (Dec-POMDP), and an autonomous decision-making mechanism is designed for content caching deployment, user association, and transmission power control. Considering diverse content caching demands and spatially heterogeneous spatial features in CF-mMIMO scenarios, a graph attention network is used to learn and capture the spatial features to achieve adaptive interference control in the process of content distribution and satisfy different service demands.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a scenario of a CF-mMIMO multi-user multi-content caching network according to some embodiments of the present disclosure;

FIG. 2 is a block diagram illustrating a GMJOC algorithm according to embodiments of the present disclosure;

FIG. 3 is a graph illustrating a convergence performance of a GMJOC algorithm according to some embodiments of the present disclosure;

FIG. 4 is a graph illustrating a variation of network rate with increasing training rounds of a GMJOC algorithm according to some embodiments of the present disclosure; and

FIG. 5 is a graph illustrating a variation of power consumption with increasing training rounds of a GMJOC algorithm according to some embodiments of the present disclosure.

### DETAILED DESCRIPTION

The following illustrates the embodiments of the present disclosure by way of specific embodiments, and a person skilled in the art may readily understand other advantages and efficacies of the present disclosure by the contents disclosed herein. The present disclosure may be implemented or applied in different ways, and the details of the present disclosure may be modified or altered based on different points of view and applications without departing from the spirit of the present disclosure. It should be noted that the drawings provided in the following embodiments illustrate the basic concept of the present disclosure in a schematic manner only, and that the following embodiments and features in the embodiments may be combined with each other without conflict.

In which the accompanying drawings are for illustrative purposes only, represent schematic drawings only, not physical drawings, and are not to be construed as a limitation of the present disclosure; in order to better illustrate the embodiments of the present disclosure, certain parts of the accompanying drawings will be omitted, enlarged, or reduced, and do not represent the dimensions of the actual product; it is understandable that certain well-known structures and their descriptions in the accompanying drawings may be omitted for those skilled in the art.

The same or similar symbols in the accompanying drawings of the embodiments of the present disclosure correspond to the same or similar components; in the descriptions of the present disclosure, it is to be understood that if there is the terminology “upper”, “down”, “left”, “right”, “front”, “back” and the like indicate an orientation or a positional relationship based on those shown in the accompanying drawings, and are only intended to facilitate the description of the present disclosure and to simplify the description, and are not intended to indicate or imply that the device or element referred to must be constructed and operated with a particular orientation or in a particular orientation, and the terms describing the positional relationship in the accompanying drawings are only intended to be used in exemplary illustrations and are not to be construed as a limitation of the present disclosure. The specific meanings of the above terms may be understood by a person of ordinary skill in the art by the specific circumstances.

In some embodiments, a cell-free massive MIMO system includes N access points (Aps) with caching resources and M mobile devices (MDs), a strategy optimization algorithm of the cell-free massive MIMO system includes: S1: constructing a user association model, the user association model is configured to model an association relationship between the M mobile devices (MDs) and the N access points (APs) in each time slot; S2: constructing a downlink signal model, the downlink signal model is configured to model a network achievable rate of the cell-free massive MIMO system in the each time slot; S3: constructing a system energy consumption model, the system energy consumption model is configured to model a total energy consumption of all the N access points (APs) providing a content service in the each time slot; S4: constructing a target optimization problem model based on the user association model, the downlink signal model, and the system energy consumption model; and S5: constructing the target optimization problem model as a partially observable Markov decision process (POMDP) model, and solving using a graph attention-based multi-agent reinforcement learning algorithm to obtain an association strategy between the N access points (APs) and the M mobile devices (MDs), a content caching strategy of the N access points (APs), and a power allocation strategy of the N access points (APs).

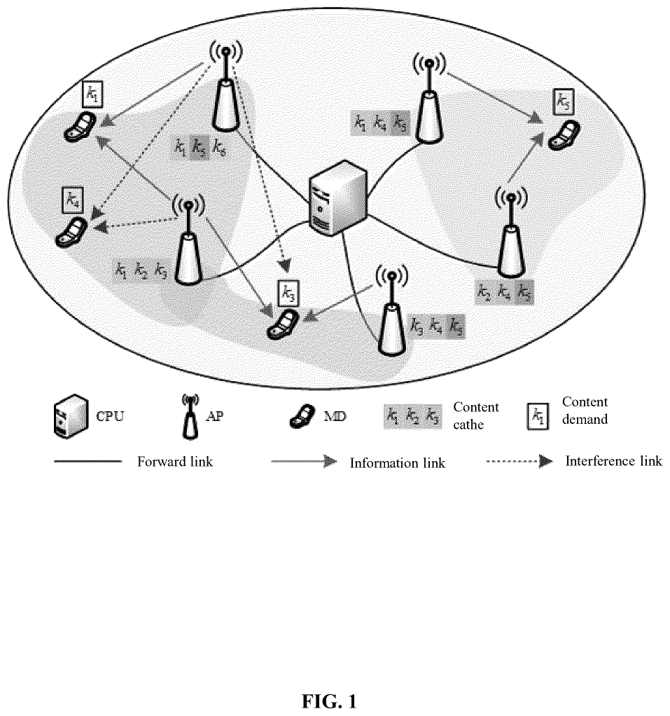

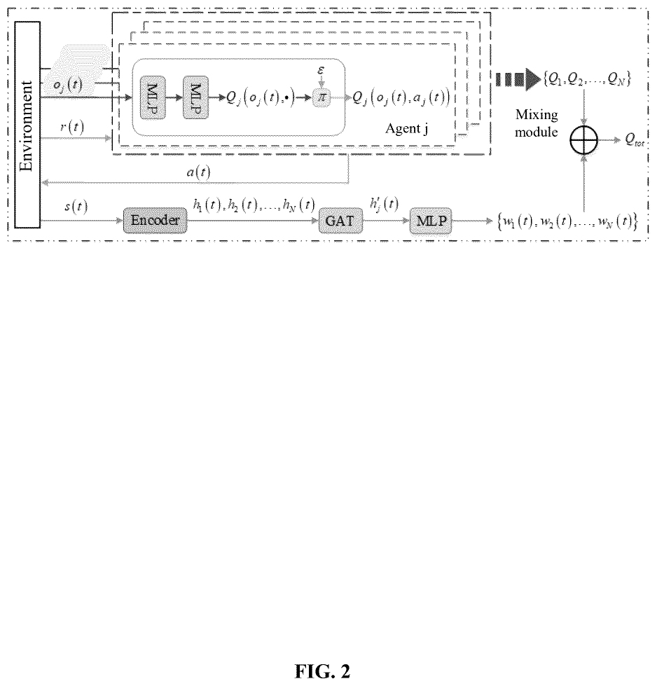

Referring to a schematic diagram illustrating a scenario of a CF-mMIMO multi-user multi-content caching network shown in FIG. 1 and a block diagram illustrating a GMJOC algorithm shown in FIG. 2, the present disclosure provides a strategy optimization algorithm for the cell-free massive MIMO system, which includes: N access points (APs) with caching resources and M mobile devices (MDs).

The mobile device (MD) refers to a terminal device that possesses mobility features within a network. For example, the mobile device (MD) may include a smartphone, a tablet, a wearable device, or the like.

The access point (AP) refers to an infrastructure node that possesses wireless communication and content caching capabilities. In some embodiments, the access point (AP) may be configured to provide wireless access and data transmission services to the mobile device.

In some embodiments, the strategy optimization algorithm may be executed by a processor of the cell-free massive MIMO system. The processor may process data and/or information obtained from the access point (AP) or other devices (e.g., storage devices). The processor may execute program instructions based on the data, information, and/or processing results to realize a plurality of functions described in the present disclosure. In some embodiments, the processor may include one or more sub-processing devices (e.g., a single-core processor or a multi-core multi-die processing device). Merely by way of example, the processor may include a central processing unit (CPU), a graphics processing unit (GPU), a controller, a microcontroller unit, a reduced instruction set computer (RISC), a microprocessor, or any combination thereof.

The storage device may be configured to store data and/or instructions. The storage device may include one or more storage components, each of which may be an independent device or may be part of other devices. In some embodiments, the storage device may include random access memory (RAM), read-only memory (ROM), mass storage, removable memory, volatile read-write memory, or the like, or any combination thereof.

In some embodiments, the strategy optimization algorithm for the cell-free massive MIMO system includes:

S1: constructing a user association model, wherein the user association model is configured to model an association relationship between M mobile devices (MDs) and N access points (APs) in each time slot.

The user association model refers to a model configured to describe and analyze a dynamic connection relationship between the mobile devices (MDs) and the access points (APs).

In some embodiments, the processor may construct the user association model in a plurality of ways. For example, the processor may construct the user association model based on channel gain, access point load, required bandwidth, or the like, of a user, using a multi-agent reinforcement learning algorithm (e.g., Q-learning or deep reinforcement learning) for access point selection and power allocation. More descriptions regarding the channel gain, the user association model may be found below and the related descriptions.

A time slot refers to a basic unit used to organize and allocate time resources. For example, the time slot may include a time interval.

S2: constructing a downlink signal model, wherein the downlink signal model is configured to model a network achievable rate of the cell-free massive MIMO system in the each time slot.

The downlink signal model refers to a model configured to describe and analyze a data transmission process from the access points (APs) to the mobile devices (MDs).

In some embodiments, the processor may construct the downlink signal model in a plurality of ways. For example, the processor may construct the downlink signal model by dynamically adjusting an allocation of downlink signals using an adaptive scheduling algorithm through real-time monitoring channel quality, load, demand, or the like, for each user. More descriptions regarding the downlink signal model may be found below and the related descriptions.

S3: constructing a system energy consumption model, wherein the system energy consumption model is configured to model a total energy consumption of all the N access points (APs) providing a content service in the each time slot.

The system energy consumption model refers to a model configured to analyze the total energy consumption of the access points (APs) providing the content service.

In some embodiments, the processor may construct the system energy consumption model in a plurality of ways. For example, the processor may construct the system energy consumption model through optimization algorithms such as linear programming, integer programming, or the like. More descriptions regarding the system energy consumption modeling may be found below and the related descriptions.

S4: constructing a target optimization problem model based on the user association model, the downlink signal model, and the system energy consumption model.

The target optimization problem model refers to a mathematical model constructed to achieve optimal system performance.

In some embodiments, the processor may construct the target optimization problem model in a plurality of ways. For example, the processor may construct the target optimization problem model by defining optimization objectives (e.g., throughput maximization, energy minimization) and constraints (e.g., the channel quality, power limitation) using approaches such as a weighted sum manner, Pareto optimal solution, reinforcement learning, or the like, for multi-objective optimization. More descriptions regarding the target optimization problem model may be found below and the related descriptions.

S5: constructing the target optimization problem model as a partially observable Markov decision process (POMDP) model, and solving using a graph attention-based multi-agent reinforcement learning algorithm to obtain an association strategy between the N access points (APs) and the M mobile devices (MDs), a content caching strategy of the N access points (APs), and a power allocation strategy of the N access points (APs).

The association strategy refers to a rule or an algorithm that is used to determine a connection relationship between mobile devices (MDs) and access points (APs) in a wireless communication network.

The content caching strategy refers a rule or an algorithm that is used to determine at which access point (AP) a content is pre-cached to optimize a request response speed of the mobile device (MD) in the wireless communication network.

The power allocation strategy refers to a rule or an algorithm that is used to optimize the transmission power deployment between the access points (APs) and the mobile devices (MDs) in the wireless communication network.

More descriptions regarding the above user association model, downlink signaling model, system energy model, and target optimization problem model may be found below and the related descriptions.

In some embodiments of the present disclosure, the user association, the content caching, and the power allocation are jointly optimized by the strategy optimization algorithm, which effectively improves the network achievable rate and energy efficiency of the cell-free massive MIMO system; and solving using a graph attention-based multi-agent reinforcement learning enhances an adaptable ability to a complex dynamic environment, reduces an overall energy consumption of the cell-free massive MIMO system, and improves a content hit rate and quality of service to satisfy differentiated content demands of mobile devices.

FIG. 1 is a schematic diagram illustrating a scenario of a CF-mMIMO multi-user multi-content caching network according to some embodiments of the present disclosure.

The embodiments of the present disclosure are illustrated based on a typical cell-free massive MIMO (CF-mMIMO) network with multi-user and multi-content caching, as shown in FIG. 1, which contains N access point (APs) and M mobile device (MDs), and defines a set of all APs and a set of all MDs as [symbol] ={1, 2, . . . , N} and [symbol] ={1, 2, . . . , M}, respectively.

k₁k₂k₃, k₁k₅k₆, k₁k₄k₅, k₂k₄k₅, and k₃k₄k₅ shown in FIG. 1 denote different content caches, different grayscale undertones of k₁˜k₅ are used to distinguish and illustrate content caches corresponding to different MDs. [symbol] , [symbol] , [symbol] , [symbol] denote content demands corresponding to the different MDs.

Solid lines shown in FIG. 1 denotes forward links. The forward links refer to links used to transmit signals from the CPU to each of the APs in a communication system.

Solid lines with arrows shown in FIG. 1 denotes information links from APs to MDs. The information links refer to links used to transmit data between the access points and the mobile devices.

Dotted lines with arrows shown in FIG. 1 denotes interference links. The interference links refer to links used to represent interference signals between different devices (e.g., different MDs and/or different APs). The interference signals may be from other signals, noise, or other factors.

In some embodiments, different mobile devices (MDs) have differentiated content demands, i.e., the different MDs generate different content requests, and the different MDs are associated with different access points (APs) according to a current network state; the current network state includes distances between each of the mobile devices (MDs) and the access points (APs), a channel state, and a content deployment state; the different access points (APs) cache corresponding service contents according to content demands within service ranges of the different access points (APs) and are connected to a central processing unit via optical fiber links.

In some embodiments, assuming that there are F equal-sized service contents in the network, defining a set of all service contents as [symbol] ={1, 2, . . . , F}. The network operates in discrete time slots, defining a set of time slots as [symbol] ={0, 1, 2, . . . }.

The content request refers to a service request initiated by a mobile device (MD) to the network to obtain a specific content based on user demands. For example, the content request may include a video-on-demand request, a music playback request, a software update package download request, etc.

The distances between each of the mobile devices (MDs) and the access points (APs) refer to physical distances between the mobile device (MD) and all the access points to which it may be connected.

The channel state refers to an operating condition of a channel or a frequency range used for transmitting data in the wireless communications.

The content deployment state refers to a status of whether or not the specific content has been cached to a certain access point (AP).

In some embodiments, the processor may associate the different MDs to the different APs in a plurality of ways. For example, the processor may comprehensively evaluate the distances between each of the mobile devices (MDs) and the access points (APs), the channel state (e.g., a signal strength, an interference), and the content deployment state to select an AP that is close, maintains excellent channel quality, and caches the requested content.

In some embodiments of the present disclosure, by comprehensively considering the distance between the mobile device and the access point, the channel state, and the content deployment state, an intelligent association between the user and the access point is realized, so that different mobile devices are able to access an appropriate access point according to the real-time network condition; at the same time, the access point performs content caching according to the content demand, which effectively reduces a pressure of a backhaul link and connects to the central processing unit through a high-speed optical fiber link to ensure fast and stable data interaction.

In some embodiments, the user association model includes formulas (1)-(5) as follows:

$${v}_{i j} ( t ) = \{ \begin{matrix}1 , & {MD}_{i} is associated with {AP}_{j} \\ 0 , & {MD}_{i} is not associated {withAP}_{j}\end{matrix} ; \qquad ( 1 )$$

$$0 < \vert {𝒱}_{i} ( t ) \vert \leq N , ∀ i , t ; \qquad ( 2 )$$

$$𝒱 ( t ) = {𝒱}_{i} ( t ) , and 𝒱 ( t ) ⊆ ; \qquad ( 3 )$$

$$= \{ 1 , 2 , … , N \} ; \qquad ( 4 )$$

$$= \{ 1 , 2 , … , M \} . \qquad ( 5 )$$

In formulas (1)-(5), [symbol] (t) denotes a set of access points (APs) associated with an i-th mobile device MDᵢ in a time slot t, t∈ [symbol] , [symbol] ={0, 1, 2, . . . } denotes a time slot set; vᵢⱼ(t)∈ [symbol] (t) denotes an association relationship between the i-th mobile device MDᵢ and a j-th access point APⱼ in the time slot t; | [symbol] (t)| denotes a count of the access points (APs) in [symbol] (t); [symbol] denotes a set of all mobile devices (MDs), [symbol] denotes a set of all access points (APs); [symbol] (t) denotes a set of all access point APs in active service in the time slot t; N denotes a count of all the access points (APs); and M denotes a count of all the mobile devices (MDs).

In some embodiments, the processor may construct the user association model. The user association model is configured to model the association relationship between the mobile devices (also referred to as MDs) and the access points (also referred to as APs) at the each time slot, and a process of constructing the user association model includes following operations.

At any time slot t, t∈ [symbol] , each MD chooses to associate to a different AP based on the distances between the MD and each of the APs, the channel state, and the content deployment state, and the association relationship between the MDs and APs in each time slot is modeled. [symbol] (t) denotes the set of APs associated with the i-th mobile device MDᵢ (i∈ [symbol] ) at the time slot t, and vᵢⱼ(t)∈ [symbol] (t) denotes the association relationship between the MDᵢ and the APⱼ (j∈ [symbol] ), vᵢⱼ(t) may be expressed as formula (1) below:

$${v}_{i j} ( t ) = \{ \begin{matrix}1 , & {MD}_{i} is associated with {AP}_{j} \\ 0 , & {MD}_{i} is not associated {withAP}_{j}\end{matrix} ; \qquad ( 1 )$$

In some embodiments, the following formula (2) is to be satisfied to ensure that all MDs are served:

$$0 < \vert {𝒱}_{i} ( t ) \vert \leq N , ∀ i , t ; \qquad ( 2 )$$

| [symbol] (t)| denotes the count of the APs in the set [symbol] (t). In addition, not all APs provide content services to the MDs, and the set of all APs in the active service in the time slot t is as the following formula (3):

$$𝒱 ( t ) = {𝒱}_{i} ( t ) , and 𝒱 ( t ) ⊆ ; \qquad ( 3 )$$

In some embodiments, the set of all APs is defined as the following formula (4):

$$= \{ 1 , 2 , … , N \} ; \qquad ( 4 )$$

In some embodiments, the set of all MDs is defined as the following formula (5):

$$= \{ 1 , 2 , … , M \} . \qquad ( 5 )$$

In some embodiments of the present disclosure, by evaluating the channel states, the distances, and the content deployment states in real time at all time slots and constructing the user association model, the cell-free massive MIMO system can dynamically adjust the association relationship between the mobile devices and the access points to ensure that all mobile devices can be effectively served; at the same time, the network load is balanced so that all mobile devices can continuously obtain stable and efficient services.

In some embodiments, the downlink signal model includes the following formulas (6)-(9) as follows:

$${R}_{s u m} ( t ) = {\sum }_{i ∈ ℬ ( t )} {R}_{i} ( t ) ; \qquad ( 6 )$$

$${R}_{i} ( t ) = {log}_{2} ( 1 + \frac{{\vert {\sum }_{j ∈ {𝒱}_{i} ( t )} {v}_{i j} ( t ) \sqrt{{P}_{i j} ( t )} {\vert {g}_{i j} ( t ) \vert}^{2} \vert}^{2}}{{\sum }_{{i}^{′} ∈ ℬ ( t ) {i}^{′} \neq i} {\vert {\sum }_{j ∈ 𝒱 ( t )} {v}_{{i}^{′} j} ( t ) \sqrt{{P}_{{i}^{′} j} ( t )} {g}_{i j} ( t ) {g}_{{i}^{′} j}^{*} ( t ) \vert}^{2} + {\vert {w}_{i} ( t ) \vert}^{2}} ) ; \qquad ( 7 )$$

$${g}_{i j} ( t ) = {( {d}_{i j} / {d}_{0} )}^{- α} {h}_{i j} ( t ) ; \qquad ( 8 )$$

$${P}_{i j} ( t ) \leq {P}_{j}^{max} . \qquad ( 9 )$$

In formulas (6)-(9), Rₛᵤₘ(t) denotes a network achievable rate of the cell-free massive MIMO system in the time slot t; Rᵢ(t) denotes a receiving signal rate of the i-th mobile device MDᵢ in the time slot t; [symbol] (t) denotes the set of access points (APs) associated with the i-th mobile device MDᵢ in the time slot t; [symbol] (t) denotes a set of mobile devices (MDs) with a service demand in the time slot t; vᵢⱼ(t) denotes the association relationship between the i-th mobile device MDᵢ and the j-th access point APⱼ in the time slot t; Pᵢⱼ(t) denotes a transmission power allocated to the i-th mobile device MDᵢ by the j-th access point APⱼ in the time slot;

$${P}_{j}^{max}$$

denotes a maximum transmission power of the j-th access point APⱼ; gᵢⱼ(t) denotes a downlink channel from the j-th access point APⱼ to the i-th mobile device MDᵢ; [symbol] (t) denotes the set of all access points (APs) in the active service in the time slot t;

$${g}_{{i}^{′} j}^{*} ( t )$$

denotes an estimated channel gain from the j-th access point APⱼ to an i′-th mobile device MD_{i′} in the time slot t; P_{i′j}(t) denotes a transmission power allocated to the i′-th mobile device MD; by the j-th access point APⱼ in the time slot t; v_{i′j}(t) denotes an association relationship between the j-th access point APⱼ and the i′-th mobile device MD_{i′} in the time slot t; wᵢ(t) denotes an interference signal received by the i-th mobile device MDᵢ in the time slot t; dᵢⱼ denotes an actual distance between the j-th access point APⱼ and the i-th mobile device MDᵢ; d₀ denotes a reference distance; α denotes a path attenuation factor; and hᵢⱼ(t) denotes small-scale fading following a complex Gaussian distribution hᵢⱼ(t)˜ [symbol] (0,1).

In some embodiments, the processor may construct the downlink signal model. The downlink signal model is configured to model the network achievable rate of the cell-free massive MIMO system in the each time slot, and a process of constructing the downlink signal model includes following operations.

In some embodiments, after the MD initiates a content request to its associated APⱼ if the AP has already cached the content, the AP transmits the content to the corresponding MD through a downlink wireless channel. The downlink channel from APⱼ to MDᵢ may be expressed as the following formula (8):

$${g}_{i j} ( t ) = {( {d}_{ij} / {d}_{0} )}^{- α} {h}_{i j} ( t ) \qquad ( 8 )$$

The downlink channel refers to a communication path between the AP and the MD in the wireless communication system.

In formula (8), gᵢⱼ(t) denotes the downlink channel from the j-th access point APⱼ to the i-th mobile device MDᵢ; dᵢⱼ denotes the actual distance between APⱼ and MDᵢ, d₀ denotes the reference distance, the reference distance is usually taken as 1 m, α denotes the path fading factor; and hᵢⱼ(t) denotes the small-scale fading following the complex Gaussian distribution hᵢⱼ(t)˜ [symbol] (0,1).

The reference distance refers to a preset standardized distance. For example, the reference distance may include 1 meter, 10 meters, etc.

In some embodiments, it is assumed that the AP transmits to the MDᵢ with a symbol qᵢ(t). [symbol] [|qᵢ(t)|²]=1, [symbol] [qᵢ(t)]=0, [symbol] denotes mathematical expectation. When the APⱼ has full channel state information, a transmission signal formed by its conjugate beam is xⱼ(t), xⱼ(t) may be expressed as:

$${x}_{j} ( t ) = {\sum }_{j ∈ 𝒱 ( t )} {v}_{ij} ( t ) \sqrt{{P}_{ij} ( t )} {\hat{g}}_{ij}^{*} ( t ) {q}_{ij} ( t ) ,$$

wherein

$${P}_{ij} ( t ) ( {P}_{ij} ( t ) \leq {P}_{j}^{max} )$$

denotes the transmission power allocated to the i-th mobile device MD; by the j-th access point APⱼ in the time slot t;

$${P}_{j}^{max}$$

denotes the maximum transmission power of the APⱼ, and

$${\hat{g}}_{ij}^{*} ( t )$$

is the estimated channel gain from the APⱼ to the MDᵢ in the time slot t.

The channel gain refers to a degree of amplification or attenuation experienced by a signal as it passes through a wireless channel.

Further, a received signal model rᵢ(t) of the MDᵢ in the time slot t may be obtained, which may be expressed as follows:

$${r}_{i} ( t ) = {\sum }_{j ∈ 𝒱 ( t )} {g}_{ij} ( t ) {x}_{j} ( t ) + {w}_{i} ( t )$$

$$= {\sum }_{j ∈ {𝒱}_{i} ( t )} {v}_{ij} ( t ) {g}_{ij} ( t ) {x}_{j} ( t ) + {\sum }_{j ∈ {𝒱}_{i}^{c} ( t )} {v}_{ij} ( t ) {g}_{ij} ( t ) {x}_{j} ( t ) + {w}_{i} ( t )$$

$$= {\underbrace{{\sum }_{j ∈ {𝒱}_{j} ( t )} {v}_{ij} ( t ) \sqrt{{P}_{ij} ( t )} {\vert {g}_{ij} ( t ) \vert}^{2} {q}_{i} ( t )}}_{useful signal} + {\underbrace{{\sum }_{j ∈ 𝒱 ( t )} {\sum }_{{i}^{′} ∈ ℬ ( t ) , {i}^{′} \neq i} {v}_{{i}^{′} j} ( t ) \sqrt{{P}_{{i}^{′} j} ( t )} {g}_{ij} ( t ) {g}_{{i}^{′} j}^{*} ( t ) {q}_{{i}^{′}} ( t ) + {w}_{i} ( t )}}_{interference signal}$$

where wᵢ(t) denotes an interference signal received by the i-th mobile device MDᵢ in the time slot t,

$${v}_{i}^{c} ( t ) = v ( t ) \backslash {v}_{i} ( t )$$

denotes a set of all Aps in the active service that do not provide service to the MDᵢ, [symbol] (t) denotes a set of the mobile devices (MDs) served by the j-th access point APⱼ in the time slot t, [symbol] (t)= [symbol] (t) denotes a set of all MDs with service demands in the time slot t; v_{i′j}(t) denotes the association relationship between the j-th access point APⱼ and the i′-th mobile device MD_{i′} in the time slot t; P_{i′j}(t) denotes the transmission power allocated to the i′-th mobile device MD_{i′} by the j-th access point APⱼ in the time slot t; gᵢⱼ(t) denotes the downlink channel from the j-th access point APⱼ to the i-th mobile device MDᵢ;

$${g}_{{i}^{′} j}^{*} ( t )$$

denotes the estimated channel gain from the j-th access point APⱼ to the i′-th mobile device MD_{i′} in time slot t; qᵢ(t) denotes the symbol transmitted from the APⱼ to the MDᵢ; q_{i′}(t) denotes a symbol transmitted from the APⱼ to the MD_{i′}.

In some embodiments, the processor may obtain the receiving signal rate Rᵢ(t) of the MDᵢ according to Shannon's formula, which may be expressed as following formula (7):

$${R}_{i} ( t ) = {log}_{2} ( 1 + \frac{{\vert {\sum }_{j ∈ {𝒱}_{i} ( t )} {v}_{ij} ( t ) \sqrt{{P}_{ij} ( t )} {\vert {g}_{ij} ( t ) \vert}^{2} \vert}^{2}}{{\sum }_{{i}^{′} ∈ ℬ ( t ) , {i}^{′} \neq i} {\vert {\sum }_{j ∈ 𝒱 ( t )} {v}_{{i}^{′} j} ( t ) \sqrt{{P}_{{i}^{′} j} ( t )} {g}_{i j} ( t ) {g}_{{i}^{′} j}^{*} ( t ) \vert}^{2} + {\vert {w}_{i} ( t ) \vert}^{2}} ) \qquad ( 7 )$$

In formula (7),

$${g}_{{i}^{′} j}^{*} ( t )$$

denotes the estimated channel gain; wᵢ(t) denotes the interference signal received by the MDᵢ in the time slot t.

Further the network achievable rate Rₛᵤₘ(t) may be expressed as following formula (6):

$${R}_{sum} ( t ) = {\sum }_{i ∈ ℬ ( t )} {R}_{i} ( t ) \qquad ( 6 )$$

In formula (6), [symbol] (t) denotes the set of all MDs with the service demands in the time slot t, Rᵢ(t) denotes the receiving signal rate of the i-th mobile device MDᵢ in the time slot t, and Rₛᵤₘ(t) denotes the network achievable rate of the cell-free massive MIMO system in the time slot t.

In some embodiments of the present disclosure, by constructing the downlink signal model, the cell-free massive MIMO system can accurately estimate the network achievable rate in all time slots, and by utilizing a joint channel expression of distance, path attenuation, and small-scale fading, the network can match appropriate transmit power and beam in real-time to improve spectral efficiency; when the content has been cached, it is directly sent locally to reduce a backhaul delay and a backbone load, thus reducing waiting time of a user while guaranteeing a high throughput.

In some embodiments, the system energy consumption model includes formulas (10) to (15) as follows:

$$P ( t ) = {\sum }_{j ∈ 𝒱 ( t )} {P}_{j} ( t ) ; \qquad ( 10 )$$

$${P}_{j} ( t ) = {P}_{j}^{AP \_ tr} ( t ) + {P}_{j}^{AP \_ up} ( t ) + {P}_{j}^{AP \_ del} ( t ) ; \qquad ( 11 )$$

$${P}_{j}^{AP \_ del} ( t ) = {P}^{FL} \cdot {σ}^{pen} \cdot \vert {ℱ}_{j}^{req} ( t ) ∖ {ℱ}_{j} ( t ) \vert ; \qquad ( 12 )$$

$${P}_{j}^{AP \_ tr} ( t ) = {P}^{FL} \cdot \vert {ℱ}_{j} ( t ) ∖ {ℱ}_{j} ( t - 1 ) \vert ; \qquad ( 13 )$$

$${P}_{j}^{AP \_ tr} ( t ) = {\sum }_{i ∈ {ℬ}_{j} ( t )} {P}_{ij} ( t ) ; \qquad ( 14 )$$

$${ℱ}_{j}^{req} ( t ) = {⋃}_{i ∈ {ℬ}_{j} ( t )} \{ {f}_{i} ( t ) \} . \qquad ( 15 )$$

In formulas (10)-(15), P(t) denotes a total energy consumption of all the access points (APs) in active service in the time slot t, [symbol] (t) denotes the set of all the access points (APs) in active service in the time slot t; Pⱼ(t) denotes a total energy consumption of the j-th access point APⱼ in the time slot t;

$${P}_{j}^{AP \_ tr} ( t )$$

denotes a downlink content transmission power consumption of the j-th access point APⱼ in the time slot t; Pᵢⱼ(t) denotes the transmission power allocated to the i-th mobile device MDᵢ by the j-th access point APⱼ in the time slot t; [symbol] (t) denotes the set of mobile devices (MDs) served by the j-th access point APⱼ in the time slot t;

$${P}_{j}^{AP \_ up} ( t )$$

denotes an energy consumption for updating or replacing a service content of the j-th access point APⱼ in the time slot t; p^{FL} denotes an energy consumption required for transmitting a unit of content over the forward link; [symbol] (t) denotes a set of service contents cached by the j-th access point APⱼ in the time slot t,

$$0 < \vert {ℱ}_{j} ( t ) \vert \leq {ℱ}_{j}^{max} , ∀ j , t , {F}_{j}^{max} < F , {F}_{j}^{max}$$

denotes a maximum content cache capacity of the j-th access point APⱼ; F denotes a count of service contents in a network; [symbol] (t−1) denotes a set of service contents cached by the j-th access point APⱼ in a time slot (t−1);

$${P}_{j}^{AP \_ del} ( t )$$

denotes a content forwarding energy consumption of the j-th access point APⱼ in the time slot t; σ^{pen} denotes an energy consumption factor for the j-th access point APⱼ obtaining an uncached content in the time slot t;

$${ℱ}_{j}^{req} ( t )$$

denotes a set of all content requests from mobile devices (MDs) associated with the j-th access point APⱼ in the time slot t; fᵢ(t)∈ [symbol] denotes a service content requested by the i-th mobile device MDᵢ in the time slot t; and [symbol] denotes a set of service contents in the network.

In some embodiments, the processor may construct the system energy consumption model. The system energy consumption model is configured to model the total energy consumption of all the N access point APs providing the content service in the each time slot, and a process of constructing the system energy consumption model includes following operations.

In some embodiments, the APs are typically equipped with limited storage resources to store only a portion of content services, while the CPU is equipped with sufficient storage resources to cache entire network content. In a CF-mMIMO network scenario, the different APs need to cache different service contents according to associated MD demands, due to a limitation of AP storage capacity, a single AP is unable to cache all the contents,

$${F}_{j}^{max}$$

is defined as the maximum content cache capacity of the j-th access point APⱼ; [symbol] (t) is defined as a set of service contents cached by the j-th access point APⱼ in the time slot t;

$${F}_{j}^{max} < F and 0 < \vert {ℱ}_{j} ( t ) \vert \leq {F}_{j}^{max} ,$$

F denotes the count of service contents in the network.

In some embodiments, it is assumed that a total count of contents in the network is F equal to 100, numbered {1, 2, . . . , 100}, the set of contents is denoted by [symbol] ; in the each time slot t, each AP caches 30 of the contents, denoted by Fⱼ(t), and each MD generates a request, denoted by fⱼ(t). The set of all content requests for all mobile devices (MDs) associated with the access point APⱼ is defined as formula (15) as follows:

$${ℱ}_{j}^{r e q} ( t ) = {⋃}_{i ∈ {ℬ}_{j} ( t )} \{ {f}_{i} ( t ) \} \qquad ( 15 )$$

In formula (15), [symbol] (t) denotes the set of MDs served by APⱼ.

In some embodiments, the strategy optimization algorithm for the cell-free massive MIMO system may further includes: in the each time slot t, if

$${ℱ}_{j}^{req} ( t ) ⋂ {F}_{j} ( t ) = ∅ ,$$

the access point AP obtaining a missing content in

$${ℱ}_{j}^{req} ( t )$$

from the CPU.

In the each time slot t, if

$${ℱ}_{j}^{req} ( t ) ⋂ {F}_{j} ( t ) = ∅ ,$$

i.e., no hit, the AP needs to obtain the missing content in

$${ℱ}_{j}^{req} ( t )$$

from the CPU, and the corresponding energy consumption may be larger than the energy consumption obtained directly from the AP. The AP may constantly adjust a caching strategy to improve a hit rate and reduce the energy consumption.

The hit refers to that a set of service contents Fⱼ(t) locally cached by a certain access point APⱼ has included

$${ℱ}_{j}^{req} ( t )$$

in a certain time slot.

$${ℱ}_{j}^{req} ( t )$$

refers to a set of all the contents requested by all the MDᵢ associated with the APⱼ in the certain time slot.

In some embodiments of the present disclosure, by monitoring an overlap of all content requests from all MDs with the contents cached in the APs in real-time, the APs can dynamically update the caching strategy to improve the hit rate and reduce the count of CPU requests for uncached contents, thereby reducing energy consumption and shortening content delivery latency.

In some embodiments, if the AP associated with the MD caches a service content requested by the MD, the AP may directly transmit the cached service content to the MD over the downlink wireless transmission link; if the AP does not cache the service content requested by the MD, the AP needs to download the corresponding service content from the CPU first and then transmit the corresponding service content to the MD over the downlink wireless transmission link.

In the process of CF-mMIMO content caching deployment and distribution, an energy consumption may include three parts as follows.

### 1) Downlink Content Transmission Power Consumption of the AP.

In some embodiments, the AP provides a service content to its associated MD, and different APs apply different transmission powers to their associated MDs based on their customized power transmission strategies. In the time slot t, the downlink content transmission power consumption

$${P}_{j}^{AP \_ tr} ( t )$$

of the APⱼ is defined as following formula (14):

$${P}_{j}^{AP \_ tr} ( t ) = {\sum }_{i ∈ {ℬ}_{j} ( t )} {P}_{ij} ( t ) \qquad ( 14 )$$

In formula (14), [symbol] (t) denotes the set of mobile devices (MDs) served by the j-th access point APⱼ in the time slot t, and Pᵢⱼ(t) denotes the transmission power allocated to the i-th mobile device MDᵢ by the j-th access point APⱼ in the time slot t.

### 2) Energy Consumption for Updating or Replacing a Service Content of the AP

In some embodiments, in order to adapt dynamic changes in MD content requests, the AP should cache, update, or replace the service content based on demands, the set of service contents cached, updated, or replaced by the APⱼ in the time slot t is [symbol] (t)\ [symbol] (t−1); further, the energy consumption for updating or replacing a service content of the APⱼ in the time slot t may be obtained as following formula (13):

$${P}_{j}^{AP \_ tr} ( t ) = {P}^{FL} \cdot \vert {ℱ}_{j} ( t ) ∖ {ℱ}_{j} ( t - 1 ) \vert \qquad ( 13 )$$

In formula (13), P^{FL} denotes the energy consumption required for transmitting a unit of content over the forward link; [symbol] (t) denotes the set of service contents cached by the j-th access point APⱼ in the time slot t; [symbol] (t−1) denotes a set of service contents cached by the j-th access point APⱼ in the time slot t−1.

### 3) Content Forwarding Energy Consumption of the AP

In some embodiments, if the AP does not cache the service content requested by the MD, the AP needs to obtain the corresponding service content from the CPU and forward it to the MD. The set of contents that the MD needs to obtain from the CPU via the APⱼ in the time slot t may be denoted as

$${ℱ}_{j}^{req} ( t ) ∖ {ℱ}_{j} ( t ) ; {ℱ}_{j}^{req} ( t )$$

denotes the set of all content requests from mobile devices (MDs) associated with the j-th access point APⱼ in the time slot t; [symbol] (t) denotes the set of service contents cached by the j-th access point APⱼ in the time slot t, therefore, the content forwarding energy consumption of the APⱼ may be defined as

$${P}_{j}^{AP \_ del} ( t )$$

as following formula (12):

$${P}_{j}^{AP \_ del} ( t ) = {P}^{FL} \cdot {σ}^{pen} \cdot \vert {ℱ}_{j}^{req} ( t ) \backslash {ℱ}_{j} ( t ) \vert \qquad ( 12 )$$

In formula (12), σ^{pen} denotes an energy consumption factor of the APⱼ to obtain an uncached content.

To summarize, the energy consumption of APⱼ in the time slot t may be obtained and expressed as following formula (11):

$${P}_{j} ( t ) = {P}_{j}^{AP \_ tr} ( t ) + {P}_{j}^{AP \_ up} ( t ) + {P}_{j}^{AP \_ del} ( t ) \qquad ( 11 )$$

In summary, the total energy consumption of all APs in the active service may be expressed as the following formula (10):

$$P ( t ) = {\sum }_{j ∈ 𝒱 ( t )} {P}_{j} ( t ) \qquad ( 10 )$$

where [symbol] (t) denotes the set of APs that provide services to the MD.

In some embodiments of the present disclosure, by constructing the system energy consumption model that incorporates the cache capacity of the APs, the network can keep only the APs with cache hits in the time slot in an active state, and the rest of the APs turn to hibernation, thus saving significant energy with limited storage. Meanwhile, frequently accessed content can be cached on demand to reduce backhaul traffic, achieving a balance between low energy consumption and low latency.

In some embodiments, the processor may construct the target optimization problem model based on the constructed user association model, downlink signal model, and system energy consumption model. In some embodiments, the process of constructing the target optimization problem model includes following operations.

In some embodiments, the AP storage resources are limited, and the content caching, user association, and power allocation problems are coupled with each other, the present disclosure models the target optimization problem model based on the AP content caching, user association, and power allocation problems with a goal of achieving a higher network rate with a certain amount of power consumption, as shown in following formulas (16) to (21).

$$P 1 : {max}_{ℱ ( t ) , 𝒱 ( t ) , P ( t )} EE = \frac{1}{T} 𝔼 \{ {\sum }_{T - 1}^{t = 0} \frac{{R}_{sum} ( t )}{P ( t )} \} \qquad ( 16 )$$

$$s . t . : 0 < \vert {𝒱}_{i} ( t ) \vert \leq N , ∀ i , t \qquad ( 17 )$$

$${v}_{ij} ( t ) ∈ \{ 0 , 1 \} , ∀ i ∈ , j ∈ \qquad ( 18 )$$

$${P}_{ij} ( t ) \leq {P}_{j}^{max} \qquad ( 19 )$$

$${\sum }_{i ∈ {ℬ}_{j} ( t )} {P}_{ij} ( t ) \leq {P}_{j}^{max} \qquad ( 20 )$$

$$0 < \vert {ℱ}_{j} ( t ) \vert \leq {F}_{j}^{max} \qquad ( 21 )$$

In formulas (16)-(21), [symbol] (t)={ [symbol] ₁(t), . . . , [symbol] (t), . . . , [symbol] _{N}(t)} denotes a content caching strategy of access points (APs) in the time slot t, [symbol] (t) denotes the set of service contents cached by the j-th access point APⱼ in the time slot t, N denotes the count of the access points (APs); [symbol] (t)={ [symbol] ₜ(t), . . . , [symbol] ₜ(t), . . . , [symbol] _{M}(t)} denotes an association strategy between the access point (APs) and mobile device (MDs) in the time slot t, [symbol] ᵢ(t) denotes the set of access points (APs) associated with the i-th mobile device MDᵢ in the time slot t, t∈ [symbol] ; [symbol] (t)={ [symbol] (t), . . . , [symbol] (t), . . . , [symbol] _{N}(t)} denotes a power allocation strategy of the access points (APs), [symbol] (t)={P₁₁(t), . . . , Pᵢⱼ(t), . . . , P_{MN}(t)} denotes a power allocation set of APⱼ, Pᵢⱼ(t) denotes the transmission power allocated to the i-th mobile device MDᵢ by the j-th access point APⱼ in the time slot t; T denotes a count of time slots; [symbol] denotes the mathematical expectation; Rₛᵤₘ(t) denotes the network achievable rate of the cell-free massive MIMO system in the time slot t; P(t) denotes a total energy consumption of all access points (APs) in active service in the time slot t; vᵢⱼ(t) denotes the association relationship between the i-th mobile device MDᵢ and the j-th access point APᵢ in the time slot t;

$${P}_{j}^{max}$$

denotes the maximum power value of the j-th access point APⱼ; [symbol] (t) denotes the set of mobile devices (MDs) served by APⱼ;

$${F}_{j}^{max}$$

denotes the maximum content cache capacity of the j-th access point APⱼ; [symbol] denotes the set of all the mobile devices (MDs); and [symbol] denotes the set of all the access points (APs).

In some embodiments of the present disclosure, by constructing the target optimization problem model, the cell-free massive MIMO system can dynamically find an optimal configuration of the time slots under constraints of cache capacity, peak power, and correlation constraints, which not only enhances the network achievable rate but also lowers the total energy consumption, realizing a balance between high speed and low power consumption.

Constructing the target optimization problem model as the partially observable Markov decision process (POMDP) model includes following operations.

Converting the target optimization problem model into a Dec-POMDP model with the N access points (APs), each of the N access points (APs) represents an intelligent agent defined by a tuple [symbol] S, { [symbol] }_{j∈N}, {Aⱼ}_{j∈N}, R, γ [symbol] , S denotes a global network environment state of the cell-free massive MIMO system; [symbol] denotes a local observation space of the j-th access point APⱼ; Aⱼ denotes an action space of the j-th access point APⱼ, R is a reward function, γ∈[0,1) denotes a discount factor.

In the time slot t, an environment state s(t)∈S is defined as follows:

$$s ( t ) = \{ {𝒦}_{1} ( t ) , {𝒦}_{2} ( t ) , … , {𝒦}_{N} ( t ) , {𝒢}_{1} ( t ) , {𝒢}_{2} ( t ) , … , {𝒢}_{N} ( t ) , {l}_{1} ( t ) , {l}_{2} ( t ) , … , {l}_{M} ( t ) \} \qquad ( 22 )$$

In formula (22), [symbol] (t)={k₁ⱼ(t), . . . , k_{fj}(t), . . . , K_{Fj}(t)} denotes a content cache state of the j-th access point APⱼ in the time slot t; k_{fj}(t)=1 denotes that the j-th access point APⱼ has cached a content f in the time slot t, otherwise k_{fj}(t)=0; [symbol] (t)={g₁ⱼ(t), . . . , gᵢⱼ(t), . . . , g_{Mj}(t)}, gᵢⱼ(t) denotes a channel gain between the j-th access point APⱼ and the i-th mobile device MD; in the time slot t; lᵢ(t) denotes location information of the i-th mobile device MDᵢ.

In the time slot t, local observation oⱼ(t)∈ [symbol] is defined as follows:

$${o}_{j} ( t ) = \{ {𝒦}_{j} ( t ) , {l}_{1} ( t ) , … , {l}_{i} ( t ) , … , {l}_{M} ( t ) \} \qquad ( 23 )$$

In the time slot t, an action aⱼ(t)∈Aⱼ is defined as follows:

$${a}_{j} ( t ) = \{ {ℱ}_{j} ( t ) , {𝒱}_{j} ( t ) , {𝒫}_{j} ( t ) \} \qquad ( 24 )$$

In formulas (23)-(24), [symbol] (t) denotes the set of service contents cached by the j-th access point APⱼ in the time slot t; [symbol] (t) denotes the set of mobile devices (MDs) associated with the j-th access point APⱼ in the time slot t; and [symbol] (t) denotes the power allocation set of the j-th access point APⱼ in the time slot t.

In the time slot t, a reward function r(t)∈R is defined as:

$$r ( t ) = R ( s ( t ) , a ( t ) ) = \frac{{R}_{sum} ( t )}{P ( t )} \qquad ( 25 )$$

In formula (25), Rₛᵤₘ(t) denotes the network achievable rate of the cell-free massive MIMO system in the time slot t; and P(t) denotes the total energy consumption of all access points (APs) in active service in the time slot t.

In some embodiments, constructing the target optimization problem model as the partially observable Markov decision process (POMDP) model, and solving using the graph attention-based multi-agent reinforcement learning algorithm includes following operations.

The present disclosure provides a Graph attention Multi-agent deep reinforcement learning based Joint Optimization of content caching, user association and resource allocation for CF-mMIMO (GMJOC), with AP as an agent, which learns the content caching strategy, the user association strategy, and the power allocation strategy, considers an existence of spatial correlation among different APs, and introduces a mechanism of multi-attention in an aggregation of network parameters to mine a correlation between the agents.

In some embodiments, the processor may transform an optimization problem P1 into the partially observable Markov decision process model (Dec-POMDP) with N APs. Each AP represents an agent and is described by the tuple S, { [symbol] }_{j∈N}, {Aⱼ}_{j∈N}, R, γ, S denotes the global network environment state of the cell-free massive MIMO system, [symbol] denotes the local observation space of the APⱼ, Aⱼ denotes the action space of the APⱼ, R denotes the reward function, γ∈[0,1) denotes the discount factor. In the time slot t, after one agent AP receives a local observation oⱼ(t)∈ [symbol] and selects an action aⱼ(t)∈Aⱼ, a joint action of all the agents (e.g., content deployment, user association, resource allocation, etc.) may be obtained, and the joint action of all the agents may be represented by a(t)∈A=A₁× . . . ×A_{N}.

In some embodiments, after the agents perform the joint action, the CF-mMIMO network environment may return a global reward r(t)=R(s(t), a(t)) and transfer a state to a next state s(t+1), s(t)∈S refers to an environment state of the CF-mMIMO in the time slot t. Next, the environment state, local observation, action space and reward function are defined as follows:

### 1) Environment State

The environmental state refers to a global state environment in which the agent is located.

In some embodiments, in the time slot t, the environment state may include content caches of all APs, channel state information, and user location state information. The environment state s(t)∈S, may be defined as formula (22) above, more descriptions regarding the environment state may be found in previous related descriptions.

### 2) Local Observation

The local observation refers to information that may be directly observed by a plurality of agents APs in the current state.

In some embodiments, in the partially observable CF-mMIMO environment, either AP is only able to observe the content caching state and the user location information of the network in the current time slot t. Therefore, the local observation of the APⱼ in the time slot t is expressed as formula (23) above, more descriptions regarding the local observation may be found in the previous descriptions related to formula (23).

### 3) Action Space

The action space refers to all possible actions that the plurality of agents APs may take.

In some embodiments, according to the optimization problem P1, variables of the APⱼ that may be optimized are content caches, user association, and power allocation; accordingly, the action aⱼ(t) of the agent APⱼ in the time slot t is defined as aⱼ(t), aⱼ(t) may be expressed as the above formula (24), more descriptions regarding the action aⱼ(t) may be found in the previous descriptions related to formula (24).

### 4) Reward Function

In some embodiments, after all of the agents perform joint actions a(t)={a₁(t), a₂(t), . . . , a_{N}(t)}, the CF-mMIMO network environment returns a global reward r(t) to evaluate the joint actions. According to the optimization problem P1, the reward function may be defined as the following formula (25):

$$r ( t ) = R ( s ( t ) , a ( t ) ) = \frac{{R}_{sum} ( t )}{P ( t )} \qquad ( 25 )$$

In some embodiments, in the partially observable network environment, the agent APⱼ receives a local observation oⱼ(t) and selects an action aⱼ(t) based on its local strategy πⱼ. π= [symbol] denotes a joint strategy of all agents, and an ultimate goal of GMJOC is to learn a strategy that optimizes the joint optimization of content caches, user association, and resource allocation strategy, to maximize the discounted cumulative global reward

$${\sum }_{h ∈ T} {γ}^{h} r ( t + h ) ,$$

h denotes an element in the set of time slots [symbol] , h=0, 1, 2 . . . . Therefore, a joint action value function may be defined as:

$${Q}^{π} ( s ( t ) , a ( t ) ) = 𝔼 [ {\sum }_{h ∈ T} {γ}^{h} r ( t + h ) \vert s ( t ) , a ( t ) ] ,$$

[symbol]

[·] denotes an expectation operation, an action value function Q^{π}(s(t), a(t)) denotes an initial state with s(t), π denotes an initial joint strategy, a(t) denotes an expectation of the discounted cumulative global reward under an initial action, and an optimal joint strategy π* denotes a joint strategy that maximizes Q^{π}(s(t), a(t)).

In some embodiments of the present disclosure, after transforming the optimization problem into the Dec-POMDP, each AP, as an independent agent, can learn a joint strategy of caching, association, and power while observing only the local information; the graph attention mechanism can aggregate states of neighboring APs to capture spatial correlations and accelerate convergence. Network energy efficiency can be continuously improved in partially observable, high-dimensional coupling scenarios, and balancing high throughput and low power consumption can be balanced.

In some embodiments, in the strategy optimization algorithm for the cell-free massive MIMO system, solving using the graph attention-based multi-agent reinforcement learning algorithm includes: a local action value network, a graph attention module, and a mixing module.

The local action value network configures a deep Q-network composed of multi-layer perceptrons for each agent, in the time slot t, the agent APⱼ receives a local observation oⱼ(t) and selects an action aⱼ(t), inputs the local observation oⱼ(t) and the action aⱼ(t) into the deep Q-network to output a local action value Qⱼ(oⱼ(t), aⱼ(t)).

The graph attention module first inputs the environment state s(t) into an MLP encoder and encodes s(t) into local potential representation vectors h₁(t), h₂(t), . . . , h_{N}(t), hⱼ(t) denotes the feature representation vector of the j-th access point APⱼ; then uses GAT to adaptively capture correlation between agents to obtain a feature representation vector hⱼ′(t) of the agent APⱼ; then inputs the feature representation vector

$${h}_{j}^{′} ( t )$$

of the agent APⱼ into the MLP encoder to generate a weight wⱼ(t) for the local action value of the agent APⱼ.

The mixing module calculates a joint action value

$${Q}_{tot} ( s ( t ) , a ( t ) ) = {\sum }_{j ∈ 𝒩} {w}_{j} ( t ) {Q}_{j} ( {o}_{j} ( t ) , {a}_{j} ( t ) )$$

based on the local action value Qⱼ(oⱼ(t), aⱼ(t)) and the weight wⱼ(t) of the local action value.

The reinforcement learning model is trained by minimizing a loss function as shown in a following formula (26):

$$L ( θ ) = {\sum }_{X}^{x = 1} ( {y}_{tot}^{x} - {Q}_{tot} ( s , a ; θ ) ) \qquad ( 26 )$$

In formula (26), θ denotes a parameter of an evaluation network, X denotes a count of mini-batch samples randomly sampled from an experience replay pool, x denotes a sample number, yₜₒₜ=r+γ max_{a′}Qₜₒₜ(s′, a′; θ⁻), r denotes a reward, a and a′ denote actions, s and s′ denotes environment states; and θ⁻ denotes a parameter of a target network.

The target optimization problem model is solved by using a trained reinforcement learning model to obtain the association strategy between the access points (APs) and the mobile devices (MDs), the content caching strategy of the access points (APs), and the power allocation strategy of the access points (APs).

Embodiments of the present disclosure construct an environment of multi-agents as an undirected graph G( [symbol] , ε), [symbol] denotes a set of nodes, each node representing an agent AP, ε denotes a set of edges representing connection relationship between the nodes, and optionally, each APⱼ has an edge with the closest AP. In the following, due to this one-to-one correspondence, the AP, the agent, and the node all denote the same object. Further, embodiments of the present disclosure use a graph-attention based value decomposition network to decompose the joint action value function into a combination of a local action value function and an attention-based relationship. The graph attention mechanism may mine spatial correlations between the APs and calculates the weight of the local action value function for each agent. The present disclosure uses a centralized training with decentralized execution (CTDE) architecture for learning. Either agent in a centralized training phase learns and updates network parameters of the agent in conjunction with the state information of other agents in the network environment. In an execution phase, each AP only needs to select its content caches, user association, and resource allocation actions based on its local observation information, and does not need to obtain global state information. A framework of the GMJOC algorithm proposed in the present disclosure is shown in FIG. 2, which includes three independent modules: 1) the local action value network of the agents, 2) the graph attention module, and 3) the mixing module.

1) Local action value network, which configures the deep Q-network (DQN) composed of multi-layer perceptrons (MLP) for the plurality of agents. As shown in FIG. 2. In the time slot t, the agent APⱼ receives the local observation of (t), and outputs the local action value function and Qⱼ(oⱼ(t), aⱼ(t)).

2) Graph attention module, as shown in FIG. 2, the graph attention module first inputs the environment state s(t) into the MLP encoder, encodes s(t) into the local potential representation vectors h₁(t), h₂(t), . . . , h_{N}(t), hⱼ(t) denotes the feature representation vector of the j-th access point APⱼ. Then, the graph attention network (GAT) may be used to adaptively capture the correlations between the agents.

In CF-mMIMO, any node (e.g., APⱼ) has a set of neighboring nodes [symbol] ( [symbol] ⊆ [symbol] ) determined by the set of edges ε, and if an edge exists between two nodes, they are considered neighbors. In GAT, attention coefficients between the node and its neighboring nodes need to be normalized using a softmax function so that comparisons may be made across the nodes. In the present disclosure, only a first-order neighboring node (including a node j) of a node APⱼ (j∈ [symbol] ) is considered, the node APⱼ denotes an agent APⱼ and its neighboring node AP_{j′} denotes the neighboring adjacent agent AP_{j′}.

In some embodiments, in the GAT, the attention coefficient between the agent APⱼ and the neighboring agent AP_{j′} of the agent APⱼ is calculated and normalized based on following formulas (27) and (28):

$${e}_{j , {j}^{′}} = att ( W \cdot {h}_{{j}^{′}} ( t ) , W \cdot {h}_{{j}^{′}} ( t ) ) \qquad ( 27 )$$

$${α}_{j , {j}^{′}} = {softmax}_{{j}^{′}} ( {e}_{j , {j}^{′}} ) = \frac{exp ( {e}_{j , {j}^{′}} )}{{\sum }_{h ∈ {ℋ}_{n}} exp ( {e}_{j , h} )} \qquad ( 28 )$$

In formulas (27) and (28), e_{j,j′} denotes the attention coefficient between the agent APⱼ and the neighboring agents AP_{j′}, indicating importance of features of the agent AP_{j′}'s to the agent APⱼ; att(·) denotes a self-attention mechanism, W is a learnable weight matrix; α_{j,j′} denotes a normalized attention coefficient; and [symbol] denotes a set of neighboring agents of the agent APⱼ.

In some embodiments of the present disclosure, by solving for the attention coefficient, the agent is able to quantify the importance of neighboring agents to its decisions in real-time. Both spatial correlation can be preserved and redundant information can be suppressed, so that the agent can learn more accurate caching, association, and power strategies under the local observation, which significantly improves training efficiency and network energy efficiency.

In order to stabilize a learning process, the present disclosure adopts a multi-head attention mechanism. After obtaining a normalized attention coefficient, the feature representation vector

$${h}_{j}^{′} ( t )$$

of the node APⱼ with L independent attention mechanisms may be expressed as follows:

$${h}_{j}^{′} ( t ) = {\vert \vert}_{l = 1}^{L} σ ( {\sum }_{{j}^{′} ∈ {ℋ}_{j}} {α}_{j , {j}^{′}}^{l} {W}^{l} {h}_{{j}^{′}} ( t ) ) ,$$

σ denotes a nonlinear function, ∥ denotes a splicing operation, and l denotes an ordinal number of the attention mechanism. Further, the MLP network takes

$${h}_{j}^{′} ( t )$$

as an input, anu generates the weight wⱼ(t) for the local action value function of the agent APⱼ.

3) Mixing module. Based on the above analysis, graph attention weights [symbol] of the mixing module may be obtained. Then the joint action value function Qₜₒₜ may be decomposed into:

$${Q}_{tot} ( s ( t ) , a ( t ) ) = {\sum }_{j ∈ 𝒩} {w}_{j} ( t ) {Q}_{j} ( {o}_{j} ( t ) , {a}_{j} ( t ) ) ,$$

the reinforcement learning model is trained by minimizing the loss function to learn the corresponding action selection strategy π, as shown in formula (26) above, more descriptions regarding the previous descriptions related to formula (26).

In some embodiments of the present disclosure, APs are modeled as nodes and neighbors as edges through the undirected graph, and neighbor information is aggregated during centralized training, and during distributed execution, APs can make decisions about caching, correlation, and power based on local observations alone, which can exploit spatial correlation to improve strategy quality, and global signaling can be avoided, realizing the cell-free massive MIMO network control with high throughput, low energy consumption, and easy deployment.

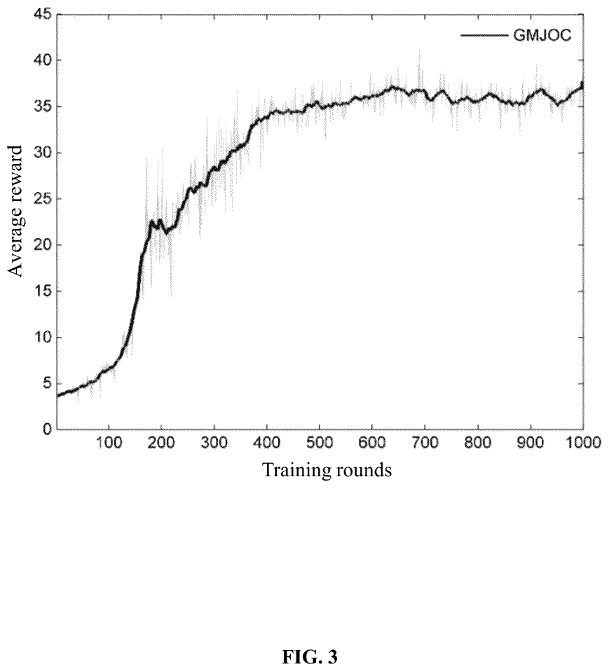

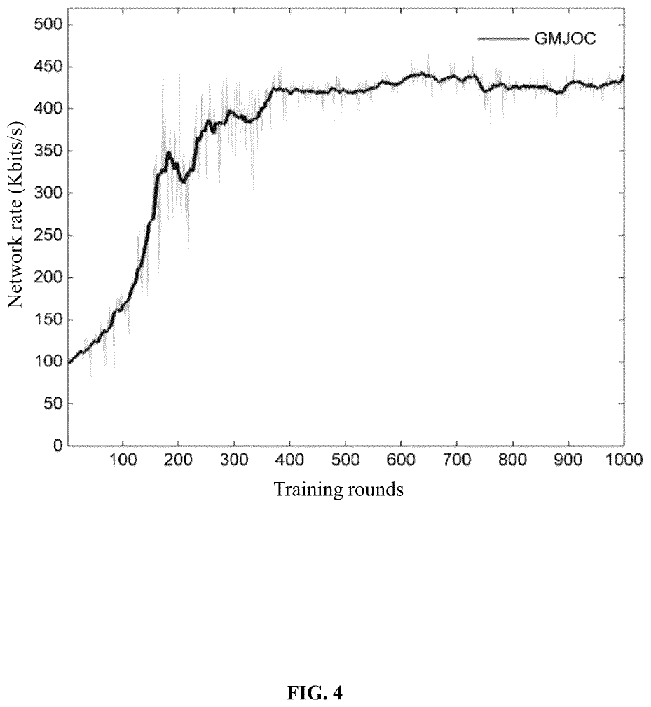

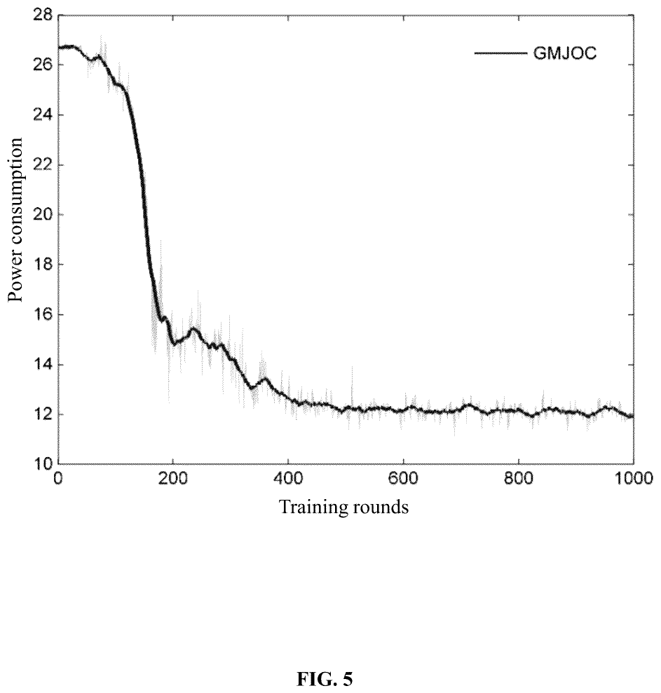

As shown in FIG. 3, the horizontal coordinate denotes a count of training rounds, the vertical coordinate denotes an average reward. As the count of training rounds increases, the average reward of the GMJOC algorithm increases continuously, and finally stabilizes around the 400-th round, when the joint action strategy of the AP does not change much, and the obtained reward value is about 4, which indicates that the agents are continuously optimizing the caching strategy, the user association strategy, and the power allocation strategy thereof. As shown in FIG. 4, the horizontal coordinate denotes a count of training rounds, the vertical coordinate denotes a network rate (in Kbits/s). A system network rate increases and eventually converges, as shown in FIG. 5, the horizontal coordinate denotes a count of training rounds, the vertical coordinate denotes power consumption (in W). The system power consumption of FIG. 5 shows a decreasing trend with the increase of training rounds, thus system energy efficiency gradually increases, which proves effectiveness of the GMJOC algorithm.

The embodiments of the present disclosure abstract the above joint optimization problem into the distributed partially observable Markov decision process (Dec-POMDP) for dynamic time-varying network environment and incomplete network state observation, and design the autonomous decision making for the content caching deployment, the user association, and the transmission power control. Considering the diverse content caching demands and wide-area differentiated spatial features in the CF-mMIMO scenarios, the graph attention network is configured to learn and capture the spatial features to achieve adaptive interference control in the process of content distribution and satisfy different business demands.

The foregoing is only an example of a better embodiment of the present disclosure, and is not intended to limit the disclosure, and any modifications, equivalent substitutions, and improvements within the spirit and principles of the present disclosure shall be included in the scope of protection of the present disclosure.

Lastly, the above embodiments are only used to illustrate the technical solutions of the present disclosure and are not intended to be limiting, and although the present disclosure has been described in detail with reference to the preferred embodiments, a person of ordinary skill in the art should understand that various modifications and equivalent substitutions may be made to the technical solutions described in the present disclosure without departing from the spirit and scope of the present technology, and all such modifications and substitutions shall fall within the scope of the claims of the present disclosure.

What is claimed is:

1. A strategy optimization algorithm for a cell-free massive MIMO system, wherein the cell-free massive MIMO system includes N access points (Aps) with caching resources and M mobile devices (MDs), the strategy optimization algorithm comprising:
S1: constructing a user association model, wherein the user association model is configured to model an association relationship between the M mobile devices (MDs) and the N access points (APs) in each time slot;
S2: constructing a downlink signal model, wherein the downlink signal model is configured to model a network achievable rate of the cell-free massive MIMO system in the each time slot;
S3: constructing a system energy consumption model, wherein the system energy consumption model is configured to model a total energy consumption of all the N access points (APs) providing a content service in the each time slot;
S4: constructing a target optimization problem model based on the user association model, the downlink signal model, and the system energy consumption model; and
S5: constructing the target optimization problem model as a partially observable Markov decision process (POMDP) model, and solving using a graph attention-based multi-agent reinforcement learning algorithm to obtain an association strategy between the N access points (APs) and the M mobile devices (MDs), a content caching strategy of the N access points (APs), and a power allocation strategy of the N access points (APs).

2. The strategy optimization algorithm according to claim 1, wherein:
different mobile devices (MDs) have differentiated content demands and are associated with different access points (APs) according to a current network state; the current network state includes a distance between each of the M mobile devices (MDs) and each of the N access points (APs), a channel state, and a content deployment state;
the different access points (APs) cache corresponding service contents according to content demands within service ranges of the different access points (APs) and are connected to a central processing unit via optical fiber links.

3. The strategy optimization algorithm according to claim 1, wherein the user association model includes formulas (1)-(5) as follows:
$${v}_{ij} ( t ) = \{ \begin{matrix}1 , & M {D}_{i} is associated with A {P}_{j} \\ 0 , & M {D}_{i} is not associated with A {P}_{j}\end{matrix} \qquad ( 1 )$$
$$0 < \vert {𝒱}_{i} ( t ) \vert \leq N , ∀ i , t \qquad ( 2 )$$
$$𝒱 ( t ) = {⋃}_{i ∈} {𝒱}_{i} ( t ) , and 𝒱 ( t ) ⊆ \qquad ( 3 )$$
$$= \{ 1 , 2 , ⋯ , N \} \qquad ( 4 )$$
$$= \{ 1 , 2 , ⋯ , M \} \qquad ( 5 )$$
where, in formulas (1)-(5), [symbol] (t) denotes a set of access points (APs) associated with an i-th mobile device MDᵢ in a time slot t, t∈ [symbol] , [symbol] ={0, 1, 2, . . . } denotes a time slot set; vᵢⱼ(t)∈ [symbol] ᵢ(t) denotes an association relationship between the i-th mobile device MDᵢ and a j-th access point APⱼ in the time slot t; | [symbol] (t)| denotes a count of the access points (APs) in [symbol] (t); [symbol] denotes a set of all mobile devices (MDs), [symbol] denotes a set of all access points (APs); [symbol] (t) denotes a set of all access point APs in active service in the time slot t; N denotes a count of all the access points (APs); and M denotes a count of all the mobile devices (MDs).

4. The strategy optimization algorithm according to claim 1, wherein the downlink signal model includes formulas (6)-(9) as follows:
$${R}_{sum} ( t ) = {\sum }_{i ∈ ℬ ( t )} {R}_{i} ( t ) \qquad ( 6 )$$
$${R}_{i} ( t ) = {log}_{2} ( 1 + \frac{{\vert {\sum }_{j ∈ {𝒱}_{i} ( t )} {v}_{ij} ( t ) \sqrt{{P}_{ij} ( t )} {\vert {g}_{ij} ( t ) \vert}^{2} \vert}^{2}}{{\sum }_{{i}^{′} ∈ ℬ ( t ) {i}^{′} \neq i} {\vert {\sum }_{j ∈ {𝒱}_{i} ( t )} {v}_{{i}^{′} j} ( t ) \sqrt{{P}_{{i}^{′} j} ( t )} {g}_{ij} ( t ) {g}_{{i}^{′} j}^{*} ( t ) \vert}^{2} + {\vert {w}_{i} ( t ) \vert}^{2}} ) \qquad ( 7 )$$
$${g}_{ij} ( t ) = {( {d}_{ij} / {d}_{0} )}^{- α} {h}_{ij} ( t ) \qquad ( 8 )$$
$${P}_{ij} ( t ) \leq {P}_{j}^{max} \qquad ( 9 )$$
where, in formulas (6)-(9), Rₛᵤₘ(t) denotes the network achievable rate of the cell-free massive MIMO system in a time slot t; Rᵢ(t) denotes a receiving signal rate of an i-th mobile device MDᵢ in the time slot t; [symbol] (t) denotes a set of access points (APs) associated with the i-th mobile device MDᵢ in the time slot t; [symbol] (t) denotes a set of mobile devices (MDs) with a service demand in the time slot t; vᵢⱼ(t) denotes an association relationship between the i-th mobile device MDᵢ and a j-th access point AP in the time slot t; Pᵢⱼ(t) denotes a transmission power allocated to the i-th mobile device MDᵢ by the j-th access point APⱼ in the time slot t;
$${P}_{j}^{max}$$
denotes a maximum transmission power of the j-th access point APⱼ; gᵢⱼ(t) denotes a downlink channel from the j-th access point APⱼ to the i-th mobile device MDᵢ; [symbol] (t) denotes a set of all access points (APs) in active service in the time slot t;
$${g}_{{i}^{′} j}^{*} ( t )$$
denotes an estimated channel gain from the j-th access point APⱼ to an i′-th mobile device MD_{i′} in the time slot t; P_{i′j}(t) denotes a transmission power allocated to the i′-th mobile device MD_{i′}, by the j-th access point APⱼ in the time slot t; v_{i′j}(t) denotes an association relationship between the j-th access point APⱼ and the i′-th mobile device MD_{i′} in the time slot t; wᵢ(t) denotes an interference signal received by the i-th mobile device MD_{i′} in the time slot t; dᵢⱼ denotes an actual distance between the j-th access point APⱼ and the i-th mobile device MDᵢ; d₀ denotes a reference distance; α denotes a path attenuation factor; and hᵢⱼ(t) denotes small-scale fading following a complex Gaussian distribution hᵢⱼ(t)˜ [symbol] (0,1).

5. The strategy optimization algorithm according to claim 1, wherein the system energy consumption model includes formulas (10)-(15) as follows:
$$P ( t ) = {\sum }_{j ∈ 𝒱 ( t )} {P}_{j} ( t ) \qquad ( 10 )$$
$${P}_{j} ( t ) = {P}_{j}^{AP \_ tr} ( t ) + {P}_{j}^{AP \_ up} ( t ) + {P}_{j}^{AP \_ del} ( t ) \qquad ( 11 )$$
$${P}_{j}^{AP \_ del} ( t ) = {P}^{FL} \cdot {σ}^{pen} \cdot \vert {ℱ}_{j}^{req} ( t ) ∖ ℱ ( t ) \vert \qquad ( 12 )$$
$${P}_{j}^{AP \_ tr} ( t ) = {P}^{FL} \cdot \vert {ℱ}_{j} ( t ) ∖ {ℱ}_{j} ( t - 1 ) \vert \qquad ( 13 )$$
$${P}_{j}^{AP \_ tr} ( t ) = {\sum }_{i ∈ {ℬ}_{j} ( t )} {P}_{ij} ( t ) \qquad ( 14 )$$
$${ℱ}_{j}^{req} ( t ) = {⋃}_{i ∈ {ℬ}_{j} ( t )} \{ {f}_{i} ( t ) \} \qquad ( 15 )$$
where, in formulas (10)-(15), P(t) denotes a total energy consumption of all access points (APs) in active service in a time slot t, [symbol] (t) denotes a set of all the access points (APs) in active service in the time slot t; Pⱼ(t) denotes a total energy consumption of a j-th access point APⱼ in the time slot t;
$${P}_{j}^{AP \_ tr} ( t )$$
denotes a downlink content transmission power consumption of the j-th access point APⱼ in the time slot t; Pᵢⱼ(t) denotes a transmission power allocated to an i-th mobile device MDᵢ by the j-th access point AP in the time slot t; [symbol] (t) denotes a set of mobile devices (MDs) served by the j-th access point APⱼ in the time slot t;
$${P}_{j}^{AP \_ up} ( t )$$
denotes an energy consumption for updating or replacing a service content of the j-th access point APⱼ in the time slot t; P^{FL} denotes an energy consumption required for transmitting a unit of content over a forward link; [symbol] (t) denotes a set of service contents cached by the j-th access point APⱼ in the time slot t,
$$0 < \vert {ℱ}_{j} ( t ) \vert \leq {F}_{j}^{max} , ∀ j , t , {F}_{j}^{max} , {F}_{j}^{max}$$
denotes a maximum content cache capacity of the j-th access point APⱼ; F denotes a count of service contents in a network; [symbol] (t−1) denotes a set of service contents cached by the j-th access point APⱼ in a time slot t−1;
$${P}_{j}^{AP \_ del} ( t )$$
denotes a content forwarding energy consumption of the j-th access point APⱼ in the time slot t; σ^{pen} denotes an energy consumption factor of the j-th access point APⱼ to obtain an uncached content;
$${ℱ}_{j}^{req} ( t )$$
denotes a set or all content requests from mobile devices (MDs) uncached content; associated with the j-th access point APⱼ in the time slot t; fᵢ(t)∈ [symbol] denotes a service content requested by the i-th mobile device MDᵢ in the time slot t, and [symbol] denotes a set of service contents in the network.

6. The strategy optimization algorithm according to claim 5, comprising:
in the each time slot t, if
$${ℱ}_{j}^{req} ( t ) ⋂ {F}_{j} ( t ) = ∅ ,$$
the access point AP obtains a missing content in
$${ℱ}_{j}^{req} ( t )$$
from a central processing unit.

7. The strategy optimization algorithm according to claim 1, wherein the target optimization problem model P1 includes formulas (16)-(21) as follows:
$${max}_{ℱ ( t ) , 𝒱 ( t ) , P ( t )} EE = \frac{1}{T} 𝔼 \{ {\sum }_{T - 1}^{t = 0} \frac{{R}_{sum} ( t )}{P ( t )} \} \qquad ( 16 )$$
$$s . t . : 0 < \vert {𝒱}_{i} ( t ) \vert \leq N , ∀ i , t \qquad ( 17 )$$
$${v}_{ij} ( t ) ∈ \{ 0 , 1 \} , ∀ i ∈ ℳ , j ∈ 𝒩 \qquad ( 18 )$$
$${P}_{ij} ( t ) \leq {P}_{j}^{max} \qquad ( 19 )$$
$${\sum }_{i ∈ {ℬ}_{j} ( t )} {P}_{ij} ( t ) \leq {P}_{j}^{max} \qquad ( 20 )$$
$$0 < \vert {ℱ}_{j} ( t ) \vert \leq {F}_{j}^{max} \qquad ( 21 )$$
where, in formulas (16)-(21), [symbol] (t)={ [symbol] ₁(t), . . . , [symbol] ⱼ(t), . . . , [symbol] _{N}(t)} denotes a content caching strategy of access points (APs) in a time slot t, [symbol] ⱼ(t) denotes a set of service contents cached by a j-th access point AP in the time slot t, N denotes a count of the access points (APs); [symbol] (t)={ [symbol] ₁(t), . . . , [symbol] ₜ(t), . . . , [symbol] _{M}(t)} denotes an association strategy between the access point (APs) and mobile device (MDs) in the time slot t, [symbol] ᵢ(t) denotes a set of access points (APs) associated with an i-th mobile device MDᵢ in the time slot t, t∈ [symbol] ; [symbol] (t)={ [symbol] ₁(t), . . . , [symbol] ⱼ(t), . . . , [symbol] _{N}(t)} denotes a power allocation strategy of the access points (APs), [symbol] ⱼ(t)={P₁₁(t), . . . , Pᵢⱼ(t), . . . , P_{MN}(t)} denotes a power allocation set of APⱼ, Pᵢⱼ(t) denotes a transmission power allocated to the i-th mobile device MDᵢ by the j-th access point APⱼ in the time slot t; T denotes a count of time slots; [symbol] denotes mathematical expectation; Rₛᵤₘ(t) denotes a network achievable rate of the cell-free massive MIMO system in the time slot t; P(t) denotes a total energy consumption of all access points (APs) in active service in the time slot t; vᵢⱼ(t) denotes an association relationship between the i-th mobile device MDᵢ and the j-th access point APⱼ in the time slot t;
$${P}_{j}^{max}$$
denotes a maximum power value of the j-th access point APⱼ; [symbol] ⱼ(t) denotes a set of mobile devices (MD) served by APⱼ;
$${F}_{j}^{max}$$
denotes a maximum content cache capacity of the j-th access point APⱼ; [symbol] denotes a set of the mobile devices (MDs); and [symbol] denotes a set of the access points (APs).

8. The strategy optimization algorithm according to claim 1, wherein the constructing the target optimization problem model as a partially observable Markov decision process (POMDP) model includes:
converting the target optimization problem model into a Dec-POMDP model with the N access points (APs), wherein each of the N access points (APs) represents an intelligent agent defined by a tuple [symbol] S, { [symbol] }_{j∈N}, {Aⱼ}_{j∈N}, R, γ [symbol] , S denote a global network environment state of the cell-free massive MIMO system; [symbol] denotes a local observation space of a j-th access point APⱼ; Aⱼ denotes an action space of the j-th access point APⱼ, R is a reward function, γ∈[0,1) denotes a discount factor; wherein
in a time slot t, an environment state s(t)∈S is defined as follows:
$$s ( t ) = \{ {𝒦}_{1} ( t ) , {𝒦}_{2} ( t ) , … , {𝒦}_{N} ( t ) , {𝒢}_{1} ( t ) , {𝒢}_{2} ( t ) , … , {𝒢}_{N} ( t ) , {l}_{1} ( t ) \} \qquad ( 22 )$$
where, in formula (22), [symbol] (t)={k₁ⱼ(t), . . . , k_{fj}(t), . . . , K_{Fj}(t)} denotes a content cache state of the j-th access point APⱼ in the time slot t; k_{fj}(t)=1 denotes that the j-th access point APⱼ has cached a content f in the time slot t, otherwise k_{fj}(t)=0; [symbol] (t)={g₁ⱼ(t), . . . , gᵢⱼ(t), . . . , gₘⱼ(t)}, gᵢⱼ(t) denotes a channel gain between the j-th access point APⱼ and i-th mobile device MDᵢ in the time slot t; lᵢ(t) denotes location information of the i-th mobile device MDᵢ;
in the time slot t, local observation oⱼ(t)∈ [symbol] is defined as follows:
$${o}_{j} ( t ) = \{ {𝒦}_{j} ( t ) , {l}_{1} ( t ) , … , {l}_{i} ( t ) , … , {l}_{M} ( t ) \} \qquad ( 23 )$$
in the time slot t, an action aⱼ(t)∈Aⱼ is defined as follows:
$${a}_{j} ( t ) = \{ {ℱ}_{j} ( t ) , {𝒱}_{j} ( t ) , {𝒫}_{j} ( t ) \} \qquad ( 24 )$$
where, in formulas (23) to (24), [symbol] (t) denotes a set of service contents cached by the j-th access point APⱼ in the time slot t; [symbol] (t) denotes a set of mobile devices (MDs) associated with the j-th access point APⱼ in the time slot t; and [symbol] (t) denotes a power allocation set of the j-th access point APⱼ in the time slot t;
in the time slot t, a reward function r(t)∈R is defined as:
$$r ( t ) = R ( s ( t ) , a ( t ) ) = \frac{{R}_{sum} ( t )}{P ( t )} \qquad ( 25 )$$
where, in formula (25), Rₛᵤₘ(t) denotes a network achievable rate of the cell-free massive MIMO system in the time slot t; and P(t) denotes a total energy consumption of all access points (APs) in active service in the time slot t.

9. The strategy optimization algorithm according to claim 8, wherein the solving using a graph attention-based multi-agent reinforcement learning algorithm includes: a local action value network, a graph attention module, and a mixing module; wherein
the local action value network configures a deep Q-network composed of multi-layer perceptrons for each agent, in the time slot t, the agent APⱼ receives a local observation oⱼ(t) and selects an action aⱼ(t), inputs the local observation oⱼ(t) and the action aⱼ(t) into the deep Q-network to output a local action value Qⱼ(oⱼ(t), aⱼ(t));
the graph attention module first inputs an environment state s(t) into an MLP encoder and encodes s(t) into local potential representation vectors h₁(t), h₂(t), . . . , h_{N}(t), where hⱼ(t) denotes feature representation f the j-th access point APⱼ; then uses GAT to adaptively capture correlation between agents to obtain a feature representation vector
$${h}_{j}^{′} ( t )$$
of the agent APⱼ; then inputs the feature representation vector
$${h}_{j}^{′} ( t )$$
of the agent into the MLP encoder to generate a weigh wⱼ(t) for the local action value of the agent APⱼ;
the mixing module calculates a joint action value
$${Q}_{tot} ( s ( t ) , a ( t ) ) = {\sum }_{j ∈ 𝒩} {w}_{j} ( t ) {Q}_{j} ( {o}_{j} ( t ) , {a}_{j} ( t ) )$$
based on the local action value Qⱼ(oⱼ(t), aⱼ(t)) and the weight with wⱼ(t) of the local action value;
a reinforcement learning model is trained by minimizing a loss function as shown in a following formula (26):
$$L ( θ ) = {\sum }_{X}^{x = 1} ( {y}_{tot}^{x} - {Q}_{tot} ( s , a ; θ ) ) \qquad ( 26 )$$
where, in formula (26), θ denotes a parameter of an evaluation network, X denotes a count−+of mini-batch samples randomly sampled from an experience replay pool, x denotes a sample number, yₜₒₜ=r+γ maxₐ′Qₜₒₜ(s′, a′; θ⁻), r denotes a reward, a and a′ denote actions, S and s′ denotes environment states; and θ⁻ denotes a parameter of a target network; and
the target optimization problem model is solved by using a trained reinforcement learning model to obtain the association strategy between the access points (APs) and the mobile devices (MDs), the content caching strategy of the access points (APs), and the power allocation strategy of the access points (APs).

10. The strategy optimization algorithm according to claim 9, comprising:
in the GAT, an attention coefficient between the agent APⱼ and a neighboring agent AP_{j′} of the agent APⱼ is calculated and normalized based on following formulas (27) and (28):
$${e}_{j , {j}^{′}} = att ( W \cdot {h}_{j} ( t ) , W , \cdot {h}_{{j}^{′}} ( t ) ) \qquad ( 27 )$$
$${α}_{j , {j}^{′}} = soft {max}_{{j}^{′}} ( {e}_{j , {j}^{′}} ) = \frac{exp ( {e}_{j , {j}^{′}} )}{{\sum }_{k ∈ {𝒦}_{n}} exp ( {e}_{j , h} )} \qquad ( 28 )$$
where, in formulas (27) and (28), e_{j,j′} denotes the attention coefficient between the agent APⱼ and the neighboring agents AP_{j′}, indicating importance of features of the agent AP_{j′}'s to the agent APⱼ; att(·)denotes a self-attention mechanism, W is a learnable weight matrix; α_{j,j′} denotes a normalized attention coefficient; and [symbol] denotes a set of neighboring agents of the agent APⱼ.
